(19) United States
(12) Patent Application Publication
(10) Pub. No.: US 2007/0007475 A1
(43) Pub. Date: Jan. 11, 2007

(54) Vacuum valve

(76) Inventors: Peter Zvokelj, Hoechst (AT); Gebhard Lutz, Schlins (AT); Florian Ehrne, Feldkirch (AT)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/177,072

(22) Filed: Jul. 7, 2005

(51) Int. Cl. F16K 31/00

(52) U.S. Cl. 251/63.6

(57) ABSTRACT

A vacuum valve comprises a valve body (1) with an inner cavity (4) through which a main passageway leads between an inlet (2) and an outlet (3) of the vacuum valve and with a main valve seat (6) which surrounds the main passageway, a main closing member (5) which is adjustable in the inner cavity (4) of the valve body between an open position, in which it is lifted from the main valve seat (6) and in which the main passageway through the vacuum valve is open, and a closed position, in which it tightly contacts the main valve seat (6) and in which the main passageway through the vacuum valve is closed, and which has an inner cavity (10) through which an additional passageway leads and an additional valve seat (14) surrounding the additional passageway, an additional closing member (11) which is adjustable in the inner cavity (10) of the main closing member (5) between an open position, in which it is lifted from the additional valve seat (14) and in which the additional passageway through the vacuum valve is open, and a closed position in which it tightly contacts the additional valve seat (14) and in which the additional passageway through the vacuum valve is closed, wherein the additional passageway runs through a changeable intermediate space (43) between the main closing member (5) and the additional closing member (11), and the size of this intermediate space (43) is changeable by means of a rotation of the additional closing member (11) relative to the main closing member (5).

### BACKGROUND OF THE INVENTION

a) Field of the Invention

The invention is directed to a vacuum valve comprising a valve body with an inner cavity through which a main passageway leads between an inlet and an outlet of the vacuum valve and with a main valve seat which surrounds the main passageway, a main closing member which is adjustable in the inner cavity of the valve body between an open position, in which it is lifted from the main valve seat and in which the main passageway through the vacuum valve is open, and a closed position, in which it tightly contacts the main valve seat and in which the main passageway through the vacuum valve is closed, and which has an inner cavity through which an additional passageway leads and an additional valve seat surrounding the additional passageway, an additional closing member which is adjustable in the inner cavity of the main closing member between an open position, in which it is lifted from the additional valve seat and in which the additional passageway through the vacuum valve is open, and a closed position in which it tightly contacts the additional valve seat and in which the additional passageway through the vacuum valve is closed.

b) Description of the Related Art

Vacuum valves of the kind mentioned above are known and are also referred to as dual port valves, soft start valves, or soft pump valves.

A vacuum valve of this kind is known, for example, from U.S. Pat. No. 5,172,722. The opening cross section or conductance of the additional passageway can be adjusted in this case in that the lifting of the additional closing member from the additional valve seat is adjusted to a desired value. In this connection, it is difficult to calibrate the adjustment of the size of the opening cross section or conductance.

Another vacuum valve of the type mentioned above in which the lifting of the additional closing member from the additional valve seat can be adjusted to a desired value is known from U.S. Pat. No. 6,814,338 B2.

Another soft start vacuum valve is known from U.S. Pat. No. 6,289,932 B1. The releasing of the main passageway on the one hand and of the additional passageway on the other hand is carried out in that an actuation piston displaces a valve rod in one or the other direction starting from a middle position.

Soft start valves in which the opening cross section or conductance of the additional passageway is adjusted by adjusting a diaphragm aperture are also known.

In other types of vacuum valves, a state of the vacuum valve with a low conductance can be achieved by providing only one individual closing member having a conical prolongation, wherein there is a relatively small gap between the valve body and the closing member when the closing member is lifted slightly from the valve seat. Vacuum regulating valves of this kind are known, for example, from the published U.S. Patent Applications US 2003/0197141 A1 and US 2004/0232369 A1.

### OBJECT AND SUMMARY OF THE INVENTION

An important object of the invention is to provide a vacuum valve of the type mentioned in the beginning in which the opening cross section or conductance of the additional passageway can be adjusted in a simple manner.

Another object of the invention is to provide a vacuum valve of the type mentioned in the beginning in which the conductance of the additional passageway can be adjusted to different values in a defined and reproducible manner.

Another object of the invention it to provide a vacuum valve of the type mentioned in the beginning in which the conductance of the additional passageway can be adjusted to a given absolute value.

Another object of the invention is to provide a vacuum valve of the type mentioned in the beginning which is economical to produce and to operate.

A vacuum valve according to the invention comprises a valve body with an inner cavity through which a main passageway leads between an inlet and an outlet of the vacuum valve and with a main valve seat which surrounds the main passageway, a main closing member which is adjustable in the inner cavity of the valve body between an open position, in which it is lifted from the main valve seat and in which the main passageway through the vacuum valve is open, and a closed position, in which it tightly contacts the main valve seat and in which the main passageway through the vacuum valve is closed, and which has an inner cavity through which an additional passageway leads and an additional valve seat surrounding the additional passageway, an additional closing member which is adjustable in the inner cavity of the main closing member between an open position, in which it is lifted from the additional valve seat and in which the additional passageway through the vacuum valve is open, and a closed position in which it tightly contacts the additional valve seat and in which the additional passageway through the vacuum valve is closed, wherein the additional passageway runs through a changeable intermediate space between the main closing member and the additional closing member, and the size of this intermediate space is changeable by means of a rotation of the additional closing member relative to the main closing member around an axis of rotation.

The conductance of the additional passageway can accordingly be changed in a simple manner through a rotation of the additional closing member relative to the main closing member. When a mark and/or a snap-in locking arrangement is provided for the rotational position of the additional closing member relative to the main closing member, the conductance of the additional passageway can be adjusted in a reproducible manner. These adjustments can also be tied to defined absolute values of the conductance of the additional passageway.

In an advantageous embodiment form of the invention, the main closing member is arranged in the valve body such that it cannot be rotated, and the additional closing member is rotated in order to adjust the conductance of the additional passageway. This rotation of the additional closing member can advantageously be carried out by a rotation of a valve rod at which the additional closing member is arranged, wherein the longitudinal axis of this valve rod forms the axis of rotation of the rotation of the additional closing member. The additional closing member has a portion that has the shape of a cylinder with a recess which is arranged in the outer surface and extends in circumferential direction of the cylinder, wherein the depth of the recess changes from a minimum initial value to a maximum end value. The outer wall of this portion of the additional closing member defines the changeable intermediate space between the main closing member and the additional closing member.

Further advantages and details of the invention are indicated in the following with reference to the embodiment example which is shown in the drawing and which leads to further objects of the invention.

### BRIEF DESCRIPTION OF THE DRAWINGS

FIG. 1 is an oblique view of a vacuum valve according to the invention;

FIG. 2 shows a longitudinal section through the vacuum valve in FIG. 1 (section line B-B of FIG. 5), wherein the main closing member and the additional closing member are in their closed positions;

FIG. 3 shows a longitudinal section corresponding to FIG. 2, wherein the main closing member is in its closed position and the additional closing member is in its open position;

FIG. 4 shows a longitudinal section corresponding to FIG. 2, wherein the main closing member and the additional closing member are in their open position;

FIG. 5 shows a cross section along line A-A of FIG. 2;

FIGS. 6 and 7 show oblique views in different rotational positions of the valve rod with the additional closing member arranged at the latter;

FIG. 8 shows a top view of the vacuum valve in viewing direction C according to FIG. 2 with the cylinder cover removed;

FIG. 9 is a section along line D-D of FIG. 8.

### DESCRIPTION OF THE PREFERRED EMBODIMENT EXAMPLES

The vacuum valve, according to the invention, that is shown in the drawing has a valve body (or a valve housing) 1 with an inlet (or an inlet opening) 2 and an outlet (or an outlet opening) 3. In the embodiment example of the invention shown in the drawing, the vacuum valve is constructed as a corner valve, i.e., the axes of the inlet 2 and of the outlet 3 are at right angles to one another.

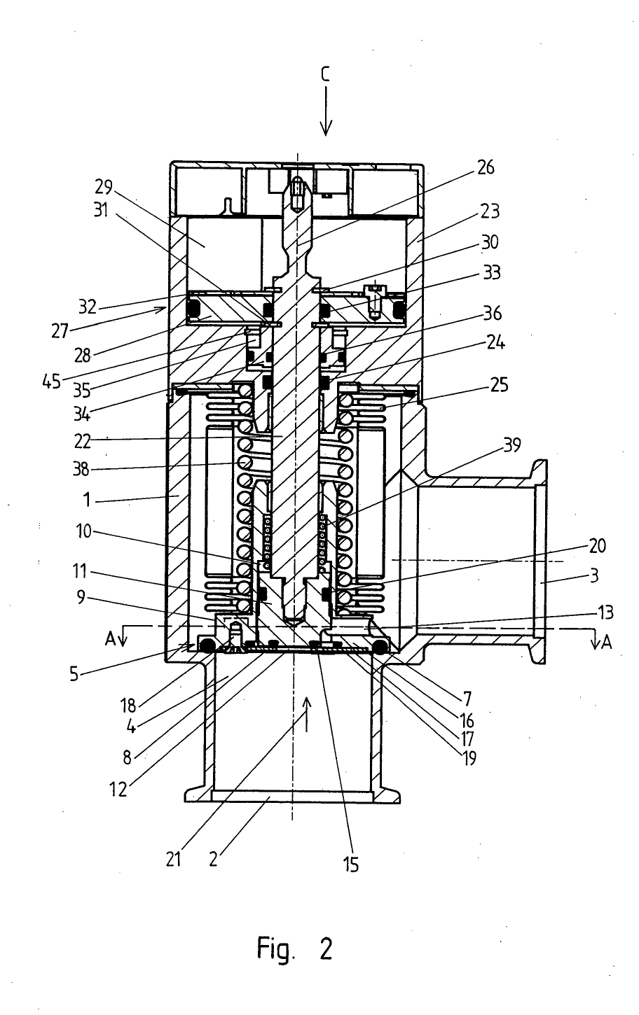

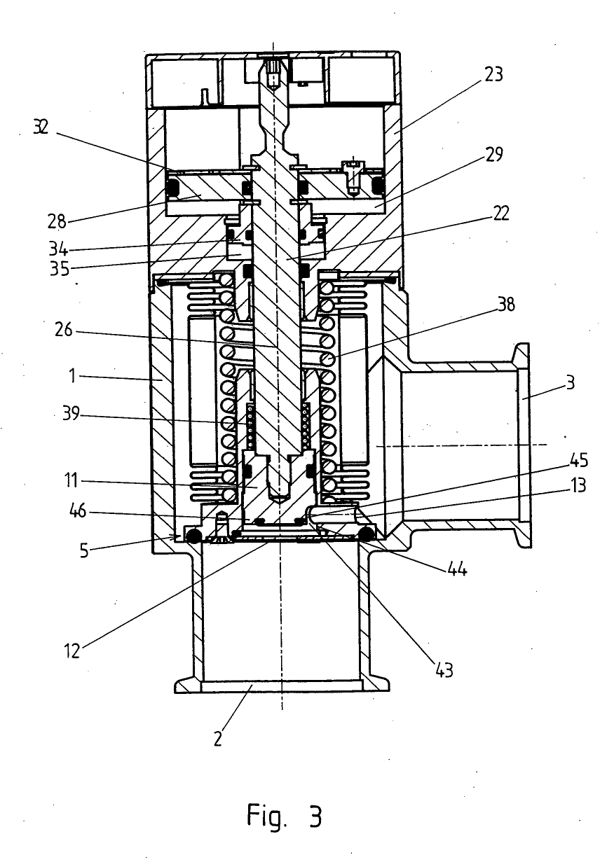

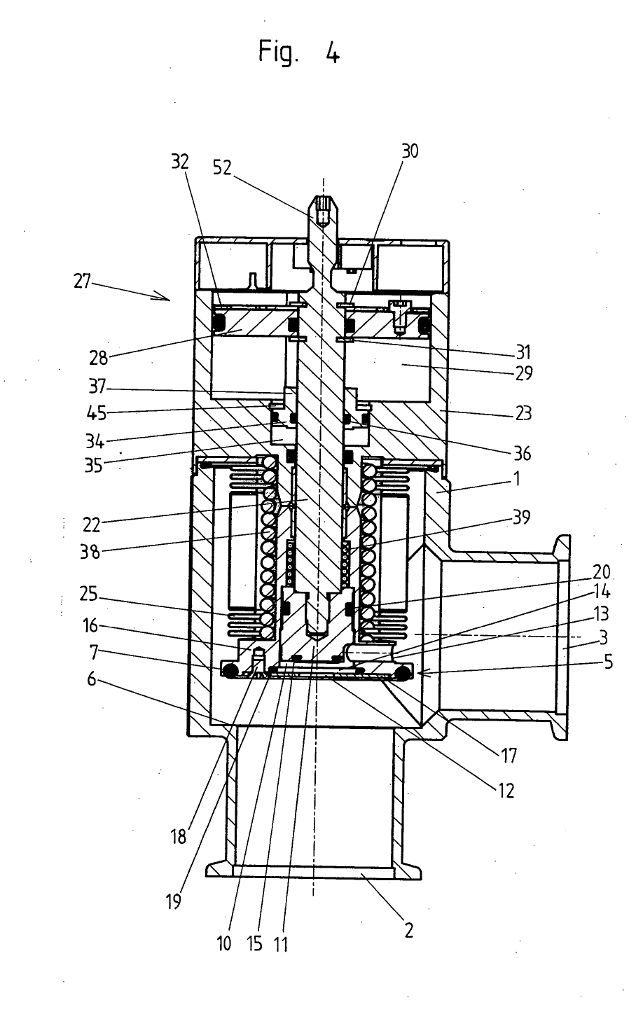

The valve body 1 has an inner cavity 4 into which the inlet 2 and the outlet 3 lead. A main closing member 5 which is adjustable between a closed position shown in FIG. 2 and FIG. 3 and an open position shown in FIG. 4, and vice versa, is arranged in this inner cavity 4. The adjusting direction is indicated by arrow 21 in FIG. 2.

In its open position, the main closing member 5 releases a main passageway for a gas between the inlet 2 and the outlet 3. This main passageway leads through the inner cavity 4 of the valve body 1. The gas can also flow through the valve in the opposite direction so that the opening designated in the drawing as inlet 2 forms the outlet and the opening designated in the drawing as outlet 3 forms the inlet.

A main valve seat 6 that is formed by a portion of the inner wall of the valve body 1 which defines the inner cavity 4 surrounds the main passageway. In the closed position, the front side of the main closing member 5 contacts the main valve seat 6, and the main closing member 5 is sealed relative to the valve body 1. In the embodiment example shown in the drawing, a sealing ring 7 which is preferably flexible is arranged at the main closing member 5 for this purpose and contacts a sealing surface of the main valve seat 6. It is also conceivable and possible to arrange the sealing ring 7 at the main valve seat 6 and to provide the sealing surface at the main closing member 5.

The portion of the main passageway surrounded by the main valve seat 6 can also be referred to as the main valve opening of the vacuum valve.

The sealing area of the main closing member 5, which contacts the main valve seat 6 in the closed position of the main closing member 5 and which is formed by the sealing ring 7 in the embodiment example shown in the drawing but could also be formed by a sealing surface contacting a sealing ring arranged at the main valve seat 6, lies between an area 8 of the outer surface of the main closing member 5 on the inlet side that is situated closer to the inlet 2 and an area 9 of the outer surface of the main closing member 5 on the outlet side that is situated closer to the outlet 3.

The main closing member 5 has an inner cavity 10. An additional closing member 11 is arranged therein and is adjustable between a closed position shown in FIG. 2 and an open position shown in FIG. 3 (in the state of the vacuum valve shown in FIG. 4, the additional closing member 11 is also in its open position), and vice versa. In the embodiment example shown in the drawing, the adjusting direction of the additional closing member 11 is parallel to the adjusting direction 21 of the main closing member 5.

In its open position, the additional closing member 11 opens an additional passageway for a gas. This additional passageway leads from the inlet 2 of the valve body 1 through a portion of the inner cavity 4 of the valve body 1 that adjoins the inlet, through an inlet opening 12 in the main closing member 5 into the inner cavity 10 of the main closing member 5, through an outlet opening 13 of the main closing member 5 out of the inner cavity 10 of the main closing member 5 into the inner cavity 4 of the valve body 1, and through the latter to the outlet 3 from the valve body 1. As was already mentioned, the gas can also flow in the opposite direction through the valve so that the additional passageway leads in the opposite direction as was described above. In this case, the opening designated in the drawing as inlet opening 12 represents the outlet opening and the opening designated in the drawing as outlet opening 13 represents the inlet opening.

The main closing member 5 has an additional valve seat 14 which surrounds the additional passageway. The additional valve seat 14 is formed by a portion of the inner wall of the main closing member 5 defining the inner cavity 10.

In its closed position, the front side of the additional closing member 11 contacts the additional valve seat 14 of the main closing member 5 and is sealed relative to the main closing member 5. For this purpose, a sealing ring 15 which is preferably flexible and which contacts a sealing surface of the additional valve seat 14 is arranged at the additional closing member 11 in the embodiment example shown in the drawing. It is also conceivable and possible that the sealing ring 15 is arranged at the additional valve seat 14 and that the additional closing member 11 contacts this sealing ring with a sealing surface in its closed position.

It can also be stated that the portion of the additional passageway enclosed by the additional valve seat 14 forms an additional valve opening which is closable by the additional closing member 11. In the embodiment example shown in the drawing, this additional valve opening lies close to the inlet opening 12 of the main closing member 5.

In the embodiment example shown in the drawing, the main closing member 5 comprises a base part 16 and a plate part 17 that is screwed to the base part 16 by means of screws 18. The parts 16, 17 are sealed relative to one another by a sealing ring 19 located therebetween. The inlet opening 12 is formed in the plate part 17, and the plate part 17 forms the additional valve seat 14.

The inlet opening 12 in the inner cavity 10 of the main closing member 5 is arranged in the inlet-side area 8 of the outer surface of the main closing member 5 and the outlet opening 13 leading from the inner cavity of the main closing member 5 is arranged in the outlet-side area 9 of the outer surface of the main closing member 5.

The additional closing member 11 is sealed relative to the inner wall defining the inner cavity 10 of the main closing member 5 by means of a sealing ring 20, and the additional closing member 11 is displaceable in the inner cavity 10 between its closed position and its open position so as to be sealed relative to the inner wall of the main closing member 5. The sealing ring 20 is at a greater distance from the inlet opening 12 than the outlet opening 13 with reference to the adjusting direction 21 of the main closing member 5 and of the additional closing member 11.

The additional closing member 11 is arranged at a valve rod 22 and is connected to the latter so as to be fixed with respect to rotation relative to it. The valve rod 22 is displaceably supported in a cylinder 23 that is rigidly connected to the valve body 1, wherein the valve rod 22 projects through a sealed slideway in the valve body 1. The sealing of the slideway is carried out by means of a flexible sealing ring 24 which is arranged in the through-hole of the slideway of the cylinder and contacts the outer surface of the valve rod 22.

In the embodiment example shown in the drawing, the cylinder 23 seals the inner cavity 4 of the valve body 1 that opens toward the cylinder 23. For this purpose, a flexible sealing ring is arranged between the cylinder 23 and the valve body 1. The cylinder 23 has a removable cylinder cover 40.

In the area of the inner cavity 4 of the valve body 1, the valve rod 22 is surrounded by a boot 25 in the form of bellows, one end of which is tightly connected to the valve body 1 while the other end is tightly connected to the main closing member 5. In FIGS. 2 to 4 and FIG. 9, the boot 25 is shown along a part of its longitudinal extension, while the rest of its longitudinal extension is only shown schematically.

The valve rod 22 acts at the rear side of the additional closing member 11 remote of the front side. This area of the inner cavity 10 of the main closing member 5 in which the rear side of the additional closing member 11 is located is sealed by means of the sealing ring 20 relative to the area of the inner cavity 10 through which the additional passageway leads.

The valve rod 22 is adjustable by an actuation mechanism 27 in the direction of its longitudinal axis 26 which lies parallel to the adjusting direction 21 of the main closing member 5 and additional closing member 11. The actuation mechanism 27 adjusts the valve rod 27 between a front end position which is shown in FIG. 2 and in which the main closing member 5 and the additional closing member 11 are in their closed positions, a defined middle position (see FIG. 3) in which the main closing member 5 is in its closed position and the additional closing member 11 is in its open position, and a rear end position which is shown in FIG. 4 and in which the main closing member 5 and the additional closing member 11 are in their open position. The middle position lies at a defined location between the front end position and the rear end position.

The actuation mechanism 27 comprises a main actuation piston 28 which is arranged in a main cylinder space 29 of the cylinder 23 and is displaceable between a front end position shown in FIG. 2 and a rear end position which is shown in FIG. 4 and in which the valve rod 22 strikes the cylinder cover 40. The main actuation piston 28 is connected to the valve rod 22 so that it is not displaceable in direction of its longitudinal axis. For this purpose, clamping rings 30, 31 are arranged at the valve rod 22, the main actuation piston 28 and another locking plate 32, described below, being arranged between these clamping rings 30,31.

The valve rod 22 is rotatable around its longitudinal axis 26 relative to the main actuation piston 28. A flexible sealing ring 33 serves to seal between the valve rod 22 and the main actuation piston 28.

The actuation mechanism 27 further comprises an additional actuation piston 34 which is arranged in an additional cylinder space 35 so as to be displaceable between a front end position shown in FIG. 2 and a rear end position shown in FIGS. 3 and 4. The additional actuation piston 34 is displaceable relative to the valve rod 22 in direction of its longitudinal axis 26. A sealing ring 36 serves to seal between the valve rod 22 and the additional actuation piston 34. In the rear end position, the additional actuation piston 34 contacts a stop 55 of the cylinder 23 which is formed by a clamping ring that is inserted into the cylinder 23.

The additional actuation piston 34 has a sleeve-like prolongation 37 which projects in the direction of the main actuation piston 28. When the main actuation piston 28 is in its front end position and the additional actuation piston 34 is displaced in direction of its rear end position starting from its front end position, the prolongation 37 presses the main actuation piston 28 in direction of its rear end position by a corresponding distance, the valve rod 22 being carried along in a corresponding manner. The valve rod 22 is in its middle position in which the additional actuation piston 34 occupies its rear end position and the prolongation 37 contacts the main actuation piston 28 (see FIG. 3). When the main actuation piston 28 is in its front end position (FIG. 2), the valve rod is in its front end position. When the main actuation piston 28 is in its rear end position (FIG. 4), the valve rod 22 is in its rear end position.

Instead of a prolongation 37 arranged at the additional actuation piston 34, a prolongation could also be arranged at the main actuation piston 28 which projects in direction of the additional actuation piston 34.

The main closing member 5 and the additional closing member 11 are pretensioned in their closed positions by means of springs 38, 39. The main closing spring 38 is arranged between the valve body 1, or the cylinder 23 that is rigidly connected to the valve body 1, and the main closing member 5. An arrangement between the cylinder cover 40 and the main actuation piston 28 is also conceivable and possible. The additional closing spring 39 is arranged between the main closing member 5 and the additional closing member 11. The closing force that is exerted on the main closing member 5 by the main closing spring 38 is greater than the closing force exerted on the additional closing member 11 by the additional closing spring 39.

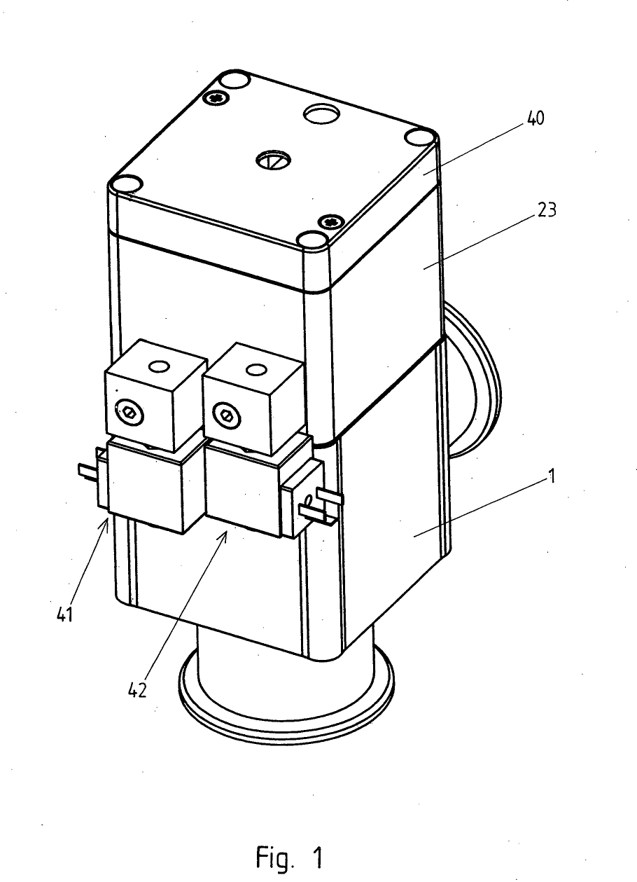

A pressure medium, preferably compressed air, is used for displacing the additional actuation piston 34 and the main actuation piston 28 into their rear end positions. This pressure medium is introduced into the respective cylinder space 29, 35 on the side of the respective piston 28, 34 facing the valve body 1. The lines and bore holes for carrying the pressure medium are not shown in the drawings for the sake of simplicity. Control valves 41, 42, shown only in FIG. 1, serve to control the pressure medium.

When the valve rod 22 is moved into its middle position, shown in FIG. 3, starting from its front end position by means of the additional actuation piston 34, the additional closing member 11 is initially lifted from the additional valve seat 14 because of the smaller closing force of the additional closing spring 39 and the additional passageway is opened. With a further adjustment of the valve rod 22 in direction of its rear end position, the additional closing member 11 runs against a stop 54 of the main closing member 5. Accordingly, due to this further displacement of the valve rod in its rear end position, the main closing member 5 is lifted from the main valve seat 6 until it reaches its open position (see FIG. 4).

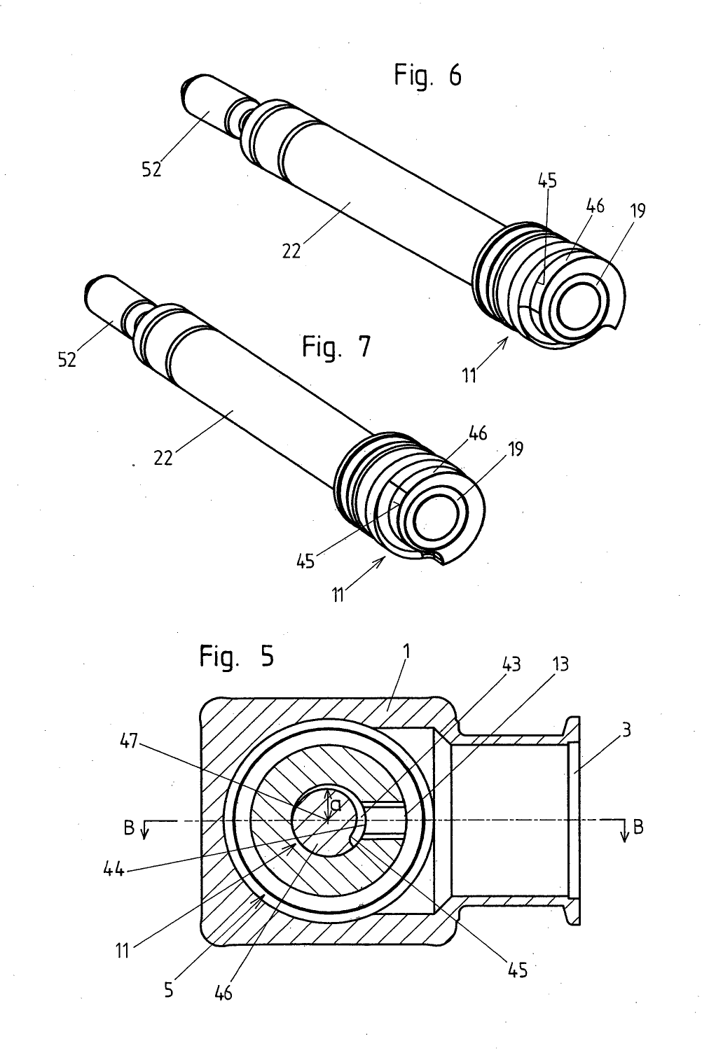

As was already mentioned, the valve rod 22 is rotatable around its longitudinal axis 26 at least over a given angular area. When the valve rod 22 rotates around its longitudinal axis 26, the additional closing member 11 is rotated correspondingly relative to the main closing member 5, specifically around the longitudinal axis 26 of the valve rod 22 as axis of rotation. This changes the size of a changeable intermediate space 43 (see FIG. 3 and FIG. 5) between the main closing member 5 and the additional closing member 11 through which the additional passageway runs. This intermediate space 43 lies between a portion 44 of the inner wall of the main closing member 5 defining the inner cavity 10 of the main closing member 5 and an outer wall 45 of a portion 46 of the additional closing member 11. As can be seen from FIG. 5, the distance a between the outer wall 45 and the axis of rotation 47 changes in circumferential direction of the additional closing member 11, at least over a portion of the total circumference of the additional closing member 11. The distance a decreases continuously from a maximum initial value to a minimum end value.

In other words, the portion 46 of the additional closing member 11 has the shape of a cylinder with a recess which is arranged in circumferential direction of the cylinder in its outer wall and whose depth changes in circumferential direction. The recess preferably extends along only a part of the total circumference as can be seen from FIGS. 5 to 7.

Accordingly, the conductance (or opening cross section) of the additional passageway varies in size depending on which part of the outer wall 45 of the portion 46 of the additional closing member 11 is located opposite from the portion 44 of the inner wall of the main closing member 5.

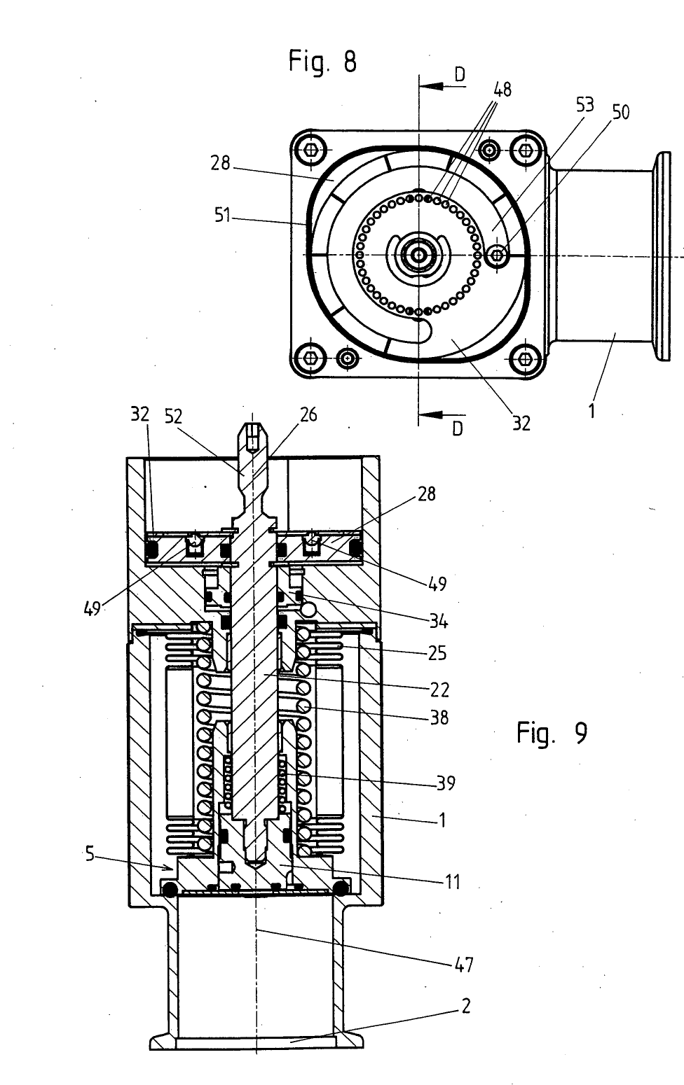

In the embodiment example shown in the drawing, a snap-in locking arrangement is provided for adjusting the conductance of the additional passageway stepwise in a reproducible manner. This snap-in locking arrangement comprises a locking plate 32 which is nonrotatably connected to the valve rod 22. The locking plate 32 has holes arranged on an imaginary circle as can be seen from FIG. 8. Snap-in balls 49 (see FIG. 9) which are arranged in the main actuation piston 28 cooperate with these holes 48. Further, the locking plate 32 has a semicircular guide opening 53 into which a stop bolt 50 arranged at the main actuation piston 28 projects. This limits the rotation of the locking plate 32 relative to the main actuation piston 28.

The main actuation piston 28 is mounted in the main cylinder space 29 in such a way that it cannot rotate around the longitudinal axis 26 of the valve rod 22. For this purpose, in the embodiment example shown in the drawing, it has an outer contour 51 which deviates from the circular shape and which cooperates with a corresponding inner contour of the main cylinder space 29 which deviates from the circular shape as can be seen in FIG. 8. Accordingly, the rotational position of the additional closing member 11 relative to the main closing member 5 can be determined by means of the locked rotational position of the locking plate 32 relative to the main actuation piston 28.

A rotation of the valve rod 22 can be carried out by means of a rotation of a handle portion 52 projecting out of the cylinder 23 in the open position of the main closing member 5.

The boot 25 provided in the embodiment example shown in the drawing also serves to hold the main closing member 5 so that it is not rotatable relative to the valve body 1. Instead of a boot 25, a sealed slideway could also be provided between the main closing member 5 and the valve body 1. In this case, the main closing member 5 would have to be provided with corresponding means for preventing rotation.

A vacuum valve according to the invention could also be constructed in a form other than that of a corner valve. For example, the inlet 2 and the outlet 3 could also be arranged along a common axis. In this case, the main valve seat 6 could be arranged at the valve body 1 so as to be inclined relative to this axis in order to guide the valve rod 22 out of the valve body 1 through a leadthrough that extends at an inclination to this axis.

Also, separate valve rods could be provided for the main closing member 5 and additional closing member 11, each of which is adjustable by means of its own actuation mechanism. In an embodiment form of the invention of this kind, the at least one valve rod at which the main closing member 5 is arranged and the valve rod at which the additional closing member is arranged are each preferably adjustable in direction of their longitudinal axis, and the longitudinal axes of the valve rods lie parallel to one another. Proceeding from the closed positions of the main closing member 5 and of the additional closing member 11, the additional closing member 11 can be moved into its open position in which it contacts a stop of the main closing member 5 by a displacement of the additional actuation piston which is arranged in its own cylinder. This limits the displacement of the additional actuation piston in its cylinder. In order to open the valve entirely, the at least one valve rod of the main closing member is displaced through the displacement of at least one main actuation piston which is arranged in its own cylinder. The additional actuation piston is carried along in its own cylinder which has a corresponding length for this purpose. A construction of this kind is suitable particularly for valves with large valve openings.

In another embodiment form of the invention, the valve body 1 can have first and second inner cavities, wherein the first inner cavity forms a main passageway through the valve and is surrounded by a main valve seat and the second inner cavity forms an additional passageway through the valve and is surrounded by an additional valve seat. The main closing member is adjustable in the first inner cavity between an open position, in which it is lifted from the main valve seat and in which the main passageway is opened, and a closed position in which the additional valve seat is tightly contacted and in which the additional passageway is closed. The additional closing member is adjustable in the second inner cavity between an open position, in which it is lifted from the additional valve seat and in which the additional passageway is opened, and a closed position in which an additional valve seat is tightly contacted and in which the additional passageway is closed. In this case, the adjustment of the main closing member and of the additional closing member can again be carried out by means of separate valve rods at which the main closing member and the additional closing member are arranged and which are adjustable in a corresponding manner by means of actuation mechanisms, preferably piston-cylinder units.

Accordingly, in this latter embodiment form, the additional passageway can be a kind of bypass to the main passageway. It is also conceivable and possible that the main passageway that can be closed by the main closing member and the additional passageway that can be closed by the additional closing member are arranged one behind the other or are connected in series. In this case, the valve body could also be formed in two parts, wherein a first valve housing has the first inner cavity with the main closing member arranged therein and a second valve housing has the second inner cavity with the additional closing member arranged therein.

In the embodiment form in which the valve body has first and second inner cavities in which the main closing member is arranged on the one hand and the additional closing member is arranged on the other hand, the changeable intermediate space through which the additional passageway runs is located between the valve body and the additional closing member. The additional closing member can be constructed in the manner described above and as shown in the drawing and can be rotated by rotating the valve rod on which it is arranged in order to change the size of the intermediate space.

As follows from the preceding description, the field of the invention is not limited to the embodiment examples shown herein, but rather should be defined with reference to the appended claims together with their full range of possible equivalents.

While the preceding description and drawings show the invention, it is obvious to the person skilled in the art that various modifications can be carried out without departing from the spirit of and field of the invention.

Reference Numbers

1 valve body
2 inlet
3 outlet
4 inner cavity
5 main closing member
6 main valve seat
7 sealing ring
8 inlet-side area
9 outlet-side area
10 inner cavity
11 additional closing member
12 inlet opening
13 outlet opening
14 additional valve seat
15 sealing ring
16 base part
17 plate part
18 screw
19 sealing ring
20 sealing ring
21 adjusting direction
22 valve rod
23 cylinder
24 sealing ring
25 boot
26 longitudinal axis
27 actuation mechanism
28 main actuation piston
29 main cylinder space
30 clamping ring
31 clamping ring
32 locking plate
33 sealing ring
34 additional actuation piston
35 additional cylinder space
36 seal
37 prolongation
38 main closing spring
39 additional closing spring
40 cylinder cover
41 control valve
42 control valve
43 intermediate space
44 portion
45 outer wall
46 portion
47 axis of rotation
48 hole
49 snap-in ball
50 stop bolt
51 outer contour
52 handle portion
53 guide opening
54 stop
55 stop

1-19. (canceled)

20. A vacuum valve comprising:
a valve body with an inner cavity through which a main passageway leads between an inlet and an outlet of the vacuum valve;
a main valve seat surrounding the main passageway;
a main closing member being adjustable in the inner cavity of the valve body between an open position, in which it is lifted from the main valve seat and in which the main passageway through the vacuum valve is open, and a closed position, in which it sealingly contacts the main valve seat and in which the main passageway through the vacuum valve is closed;
said main closing member having an inner cavity through which an additional passageway leads and an additional valve seat surrounding the additional passageway;
an additional closing member being adjustable in the inner cavity of the main closing member between an open position, in which it is lifted from the additional valve seat and in which the additional passageway through the vacuum valve is open, and a closed position in which it sealingly contacts the additional valve seat and in which the additional passageway through the vacuum valve is closed; and
wherein the additional passageway runs through a changeable intermediate space between the main closing member and the additional closing member, and the size of this intermediate space being changeable by rotation of the additional closing member relative to the main closing member.

21. The vacuum valve according to claim 20, wherein the additional closing member is adjustable with respect to its displacement between its open position and its closed position in an adjusting direction and an axis of rotation around which the additional closing member is rotatable relative to the main closing member lies parallel to this adjusting direction.

22. The vacuum valve according to claim 21, wherein the main closing member is adjustable between its open position and its closed position in an adjusting direction which lies parallel to the adjusting direction of the additional closing member.

23. The vacuum valve according to claim 20, wherein the main closing member is not rotatable relative to the valve body.

24. The vacuum valve according to claim 20, wherein the adjustable intermediate space lies between a portion of the inner wall of the main closing member defining the inner cavity of the main closing member and an outer wall of a portion of the additional closing member, wherein the distance between this outer wall and an axis of rotation around which the additional closing member is rotatable relative to the main closing member changes in circumferential direction of the additional closing member.

25. The vacuum valve according to claim 24, wherein the distance between the outer wall and the axis of rotation decreases continuously in circumferential direction of the additional closing member from a maximum initial value to a minimum end value.

26. The vacuum valve according to claim 20, wherein the additional closing member is arranged at a valve rod which is mounted so as to be rotatable around its longitudinal axis, wherein the valve rod carries the additional closing member along with it when rotating about its longitudinal axis and rotates this additional closing member relative to the main closing member.

27. The vacuum valve according to claim 26, wherein the valve rod is adjustable by an actuation mechanism in the direction of its longitudinal axis between a front end position in which the main closing member and the additional closing member are in their closed positions, a middle position in which the main closing member is in its closed position and the additional closing member is in its open position, and a rear end position in which the main closing member and the additional closing member are in their open position, wherein the middle position lies at a defined location between the front end position and the rear end position.

28. The vacuum valve according to claim 27, wherein the actuation mechanism has a main actuation piston which is connected to the valve rod so as to be immovable in direction of its longitudinal axis and which is arranged in a main cylinder space so as to be displaceable between a front end position and a rear end position, and an additional actuation piston which is arranged in an additional cylinder space so as to be displaceable between a front end position and a rear end position, the valve rod being mounted so as to be displaceable in direction of its longitudinal axis relative to this additional actuation piston, and when the additional actuation piston is displaced between its front end position and its rear end position it displaces the main actuation piston into a middle position in which the valve rod is located in its middle position in that the additional actuation piston makes contact with this main actuation piston communicating in its front end position.

29. The vacuum valve according to claim 27, wherein there is a main closing spring acting upon the main closing member in its closed position and an additional closing spring acting upon the additional closing member in its closed position, wherein the main closing spring exerts a greater closing force on the main closing member than that exerted on the additional closing member by the additional closing spring.

30. The vacuum valve according to claim 29, wherein the main closing member has a stop for limiting the lifting of the additional closing member from the additional valve seat.

31. The vacuum valve according to claim 26, wherein the valve rod is surrounded by a boot in the area of the inner cavity of the valve body, which boot is tightly connected at one end to the valve body and is tightly connected at its other end to the main closing member.

32. The vacuum valve according to claim 20, wherein the additional closing member is sealed relative to the main closing member by a flexible sealing ring arranged at its outer wall.

33. The vacuum valve according to claim 28, wherein the main actuation piston is nonrotatably arranged in the main cylinder space.

34. The vacuum valve according to claim 33, wherein the main actuation piston has a circumferential contour that diverges from the circular shape and the main cylinder space has a corresponding inner contour diverging from the circular shape.

35. The vacuum valve according to claim 26, wherein a snap-in locking arrangement is provided for locking the adjusted rotational position of the valve rod.

36. The vacuum valve according to claim 35, wherein the snap-in locking arrangement comprises a locking plate which is nonrotatably connected to the valve rod and which contacts the main actuation piston and is rotatable relative to it and can be locked in different rotational positions with the main actuation piston.

37. The vacuum valve according to claim 36, wherein the main actuation piston has at least one snap-in ball which cooperates with holes in the locking plate.

38. A vacuum valve comprising:
a valve body with a first inner cavity through which a main passageway leads between an inlet and an outlet of the vacuum valve;
a main valve seat which surrounds the main passageway;
a second inner cavity of the valve body through which an additional passageway leads;
an additional valve seat surrounding the additional passageway;
a main closing member being adjustable in the first inner cavity of the valve body between an open position, in which it is lifted from the main valve seat and in which the main passageway through the vacuum valve is open, and a closed position, in which it sealingly contacts the main valve seat and in which the main passageway through the vacuum valve is closed;
an additional closing member being adjustable in the second inner cavity of the valve body between an open position, in which it is lifted from the additional valve seat and in which the additional passageway through the vacuum valve is open, and a closed position in which it sealingly contacts the additional valve seat and in which the additional passageway through the vacuum valve is closed; and
wherein the additional passageway runs through a changeable intermediate space between the valve body and the additional closing member, and the size of this intermediate space being changeable by rotation of the additional closing member relative to the valve body.
